(19) United States
(12) Patent Application Publication
(10) Pub. No.: US 2016/0261418 A1
(43) Pub. Date: Sep. 8, 2016

(54) POWER OVER ETHERNET (POE) POWERED NETWORK ADAPTER INCORPORATING OPEN VSWITCH (OVS) AND FABRIC ATTACH (FA) CAPABILITIES

(71) Applicant: AVAYA INC., Basking Ridge, NJ (US)

(72) Inventors: Carl Keene, Santa Clara, CA (US); Dennis Flynn, Merrimack, NH (US); Paul Unbehagen, Santa Clara, CA (US)

(73) Assignee: AVAYA INC., Basking Ridge, NJ (US)

(21) Appl. No.: 14/657,278

(22) Filed: Mar. 13, 2015

Related U.S. Application Data
(60) Provisional application No. 62/129,340, filed on Mar. 6, 2015.

(51) Int. Cl. H04L 12/10; G06F 1/26; G06F 21/57

(52) U.S. Cl. CPC H04L 12/10; G06F 21/575; G06F 1/266; G06F 2221/033

(57) ABSTRACT

A POE powered network adapter incorporating OVS and FA capabilities includes one or more Ethernet ports. The device derives power from an external source over one of the Ethernet ports and delivers power over at least one other Ethernet port or ports to attached devices. Further, the device does not use a fan for cooling and uses an Open Flow compliant software based Datapath implementation. The OF compliant software based Datapath implementation is OVS. The device could also run proprietary vendor software. The device implements the Fabric Attach/Auto Attach (FA/AA) client/proxy capabilities. Additionally, embodiments include secure boot technologies to ensure that the only operational images that can be loaded on these device(s) are the ones that are approved by the vendor of the equipment. Additionally, coupling of the device to a specified device is supported wherein communication between said device and any other device is rejected.

### CROSS REFERENCE TO RELATED APPLICATIONS

The present application claims the benefit of U.S. Provisional Patent Application No. 62/129,340, filed on Mar. 6, 2015, which is incorporated herein by reference in its entirety.

### BACKGROUND

Open VSwitch (OVS) is a software based Datapath implementation that is being used to deliver Open Source based products and services with Software Defined Networking (SDN) capabilities. Software based Datapath implementations have allowed enterprise and cloud data center operators to deploy a variety of SDN enabled business applications in a manner that was not possible earlier due to the limitations of working with fixed silicon functions and proprietary management and control interfaces in the networking hardware. OVS is playing an extremely important role in enabling SDN. It has a very comprehensive set of Datapath capabilities, is open source, very stable, supported a large community of developers and is currently in most main stream Linux distributions. The attention of most of the vendors and operators in terms of SDN has so far been in the Data Center and implementations of OVS have centered around servers or dedicated hardware in traditional switch like form factors or Network Interface controller (NIC) cards in servers.

The following terms are used throughout the application and are herein defined. A network edge device primarily enables a local user to connect and transfer data to a network, which is external or is non-propriety to the organization/user. An edge device serves as the entry point into a service provider, carrier or an enterprise primary network. They also provide network translation between networks that use different protocols. For example, an edge device will translate and transfer packets and cells in between an Ethernet and ATM network.

Power over Ethernet (PoE) describes any of several standardized or ad-hoc systems which pass electrical power along with data on Ethernet cabling. This allows a single cable to provide both data connection and electrical power to devices. Power may be carried on the same conductors as the data, or it may be carried on dedicated conductors in the same cable. The PoE standard provides up to 15.4 W of DC power (minimum 44 V DC and 350 mA to each device. Only 12.95 W is assured to be available at the powered device as some power dissipates in the cable. The PoE standard known as PoE+ or PoE plus, provides up to 25.5 W of power. Another PoE implementation is called Universal Power over Ethernet (UPOE). UPOE can use all 4 pairs, after negotiation, to supply up to 60 W.

Fabric Attach/Auto Attach (referred to herein collectively as simply FA/AA or FA) allows network operators to extend network virtualization directly into the conventional wiring closet (on existing non-fabric switches) and automate the provisioning of devices to their appropriate virtual network. This is particularly relevant for the mass of unattended network end-point that are now appearing. Fabric Attach leverages ID Engines and standardized protocols to exchange credentials and obtain provisioning information that allows Client switches to be automatically re-configured on the fly with parameters that let traffic flows map through to edge switches functioning as a Fabric Attach server switch.

### SUMMARY

Little attention has been paid to the fact that the network edge/access layer has similar needs in terms of SDN enabling end devices, hosts and in some case access layer switches. While the goals are similar—the constraints are quite different. These include power, cooling, outdoor environment, as well as an increased possibility of being stolen, lost or misplaced because of their proximity to end user devices (not always under lock and key in a wiring closet).

The pressing need here is for vendors to find a delivery vehicle for SDN enabling the network edge without having to make a different technology choice each time a different business problem needs to be addressed. In other words there is a need to find a way to package the benefits of fully flexible software Datapath (and particularly the OVS) in a manner that is more suitable for the network edge.

In a particular embodiment a computerized device (network edge device), is configured to process all the method operations disclosed herein as embodiments of the invention. In such embodiments, the computerized device includes a memory system, a processor, communications interface in an interconnection mechanism connecting these components. The memory system is encoded with a process that provides a Power over Ethernet (POE) powered network adapter incorporating Open VSwitch (OVS) and Fabric Attach (FA) capabilities as explained herein that when performed (e.g. when executing) on the processor, operates as explained herein within the computerized device to perform all of the method embodiments and operations explained herein as embodiments of the invention. Thus any computerized device that performs or is programmed to perform the processing explained herein is an embodiment of the invention.

In another embodiment, a method for providing Power over Ethernet (POE) powered network adapter incorporating Open VSwitch (OVS) and Fabric Attach (FA) includes deriving power from an external source over at least one Ethernet port. The method further includes delivering power over at least one other Ethernet port to an attached device; and using an Open Flow (OF) compliant software based Datapath implementation.

Other embodiments include a computer readable medium having computer readable code thereon for providing Power over Ethernet (POE) powered network adapter incorporating Open VSwitch (OVS) and Fabric Attach (FA). The computer readable medium includes instructions for deriving power from an external source over at least one Ethernet port. The computer readable medium also includes instructions for delivering power over at least one other Ethernet port to an attached device. The compute readable medium additionally includes instructions for using an Open Flow (OF) compliant software based Datapath implementation.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing Power over Ethernet (POE) powered network adapter incorporating Open VSwitch (OVS) and Fabric Attach (FA) as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers or on one computer alone.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices such as those manufactured by Avaya, Inc. of Basking Ridge, N.J.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a POE powered network adapter incorporating OVS and FA capabilities in accordance with embodiments of the present invention.

FIG. 2 is a flow diagram of a particular embodiment of a method of providing a Power over Ethernet (POE) powered network adapter incorporating Open VSwitch (OVS) and Fabric Attach (FA) in accordance with embodiments of the present invention.

### DETAILED DESCRIPTION

The embodiments set forth below represent the necessary information to enable those skilled in the art to practice the invention and illustrate the best mode of practicing embodiments of the invention. Upon reading the following description in light of the accompanying figures, those skilled in the art will understand the concepts of the invention and recognize applications of these concepts not particularly addressed herein. It should be understood that these concepts and applications fall within the scope of the disclosure and the accompanying claims.

The preferred embodiment of the invention will now be described with reference to the accompanying drawings. The invention may, however, be embodied in many different forms and should not be construed as limited to the embodiment set forth herein; rather, this embodiment is provided so that this disclosure will be thorough and complete, and will fully convey the scope of the invention to those skilled in the art. The terminology used in the detailed description of the particular embodiment illustrated in the accompanying drawings is not intended to be limiting of the invention. In the drawings, like numbers refer to like elements.

Networking vendors primarily ship fixed function silicon for the wired network edge. Wireless APs are relatively more advanced in terms of incorporating a software based or software defined Datapath. A networking vendor is forced to make a technology choice of their equipment that is different for each different kind of deployment. This decreases flexibility, agility and the forces higher R&D investments to try and keep up.

In a particular embodiment the POE powered network adapter incorporating OVS and FA capabilities (also referred to herein simply as a device) includes one or more Ethernet ports. The device derives power from an external source over one of the Ethernet ports (using technologies like PoE/PoE+/UPoE and the like) and delivers power over at least one other Ethernet port or ports (using technologies like PoE/PoE+/UPoE and the like) to attached devices. Further, the device does not use a fan for cooling and uses an Open Flow compliant software based Datapath implementation. In certain embodiments the OF compliant software based Datapath implementation is OVS. In another embodiment the device implements the Fabric Attach/Auto Attach (FA/AA) client/proxy capabilities. Additionally, embodiments include secure boot technologies to ensure that the only operational images that can be loaded on these device(s) are the ones that are approved by the vendor of the equipment. This secures the device against jail-breaking.

The presently described device delivers the flexibility of software programmability to the network edge and allows a networking vendor to re-use the same technology vehicle to deliver and customize products that meet the requirements of a variety of business applications at the network edge. The present invention provides an innovative way to package and integrate open source software with other standard technologies that are required at the network edge, additionally; the device could also run proprietary vendor software.

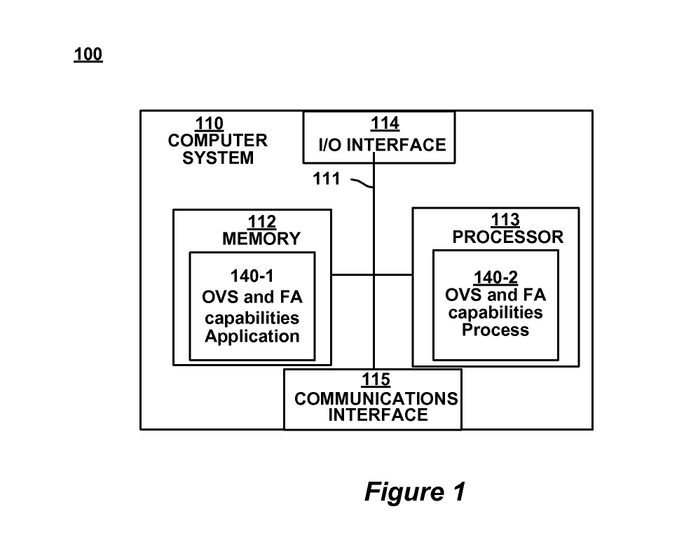

FIG. 1 is a block diagram illustrating example architecture of a computer system (a network edge device) 110 that executes, runs, interprets, operates or otherwise performs an OVS and FA capabilities operating application 140-1 and an OVS and FA capabilities operating process 140-2 suitable for use in explaining example configurations disclosed herein. As shown in this example, the computer system 110 includes an interconnection mechanism 111 such as a data bus or other circuitry that couples a memory system 112, a processor 113, an input/output interface 114, and a communications interface 115. The communications interface 115 enables the computer system 110 to communicate with other devices (i.e., other computers) on a network (not shown).

The memory system 112 is any type of computer readable medium, and in this example, is encoded with an OVS and FA capabilities operating application 140-1 as explained herein. The OVS and FA capabilities operating application 140-1 may be embodied as software code such as data and/or logic instructions (e.g., code stored in the memory or on another computer readable medium such as a removable disk) that supports processing functionality according to different embodiments described herein. During operation of the computer system 110, the processor 113 accesses the memory system 112 via the interconnect 111 in order to launch, run, execute, interpret or otherwise perform the logic instructions of an OVS and FA capabilities operating application 140-1. Execution of an OVS and FA capabilities operating application 140-1 in this manner produces processing functionality in the OVS and FA capabilities operating process 140-2. In other words, the OVS and FA capabilities operating process 140-2 represents one or more portions or runtime instances of an OVS and FA capabilities operating application 140-1 (or the entire an OVS and FA capabilities operating application 140-1) performing or executing within or upon the processor 113 in the computerized device 110 at runtime.

It is noted that example configurations disclosed herein include the OVS and FA capabilities operating application 140-1 itself (i.e., in the form of un-executed or non-performing logic instructions and/or data). The OVS and FA capabilities operating application 140-1 may be stored on a computer readable medium (such as a floppy disk), hard disk, electronic, magnetic, optical, or other computer readable medium. An OVS and FA capabilities operating application 140-1 may also be stored in a memory system 112 such as in firmware, read only memory (ROM), or, as in this example, as executable code in, for example, Random Access Memory (RAM). In addition to these embodiments, it should also be noted that other embodiments herein include the execution of an OVS and FA capabilities operating application 140-1 in the processor 113 as the OVS and FA capabilities operating process 140-2. Those skilled in the art will understand that the computer system 110 may include other processes and/or software and hardware components, such as an operating system not shown in this example.

During operation, processor 113 of computer system 110 accesses memory system 112 via the interconnect 111 in order to launch, run, execute, interpret or otherwise perform the logic instructions of the OVS and FA capabilities application 140-1. Execution of OVS and FA capabilities application 140-1 produces processing functionality in OVS and FA capabilities process 140-2. In other words, the OVS and FA capabilities process 140-2 represents one or more portions of the OVS and FA capabilities application 140-1 (or the entire application) performing within or upon the processor 113 in the computer system 100.

It should be noted that, in addition to the OVS and FA capabilities process 140-2, embodiments herein include the OVS and FA capabilities application 140-1 itself (i.e., the un-executed or non-performing logic instructions and/or data). The OVS and FA capabilities application 140-1 can be stored on a computer readable medium such as a floppy disk, hard disk, or optical medium. The OVS and FA capabilities application 140-1 can also be stored in a memory type system such as in firmware, read only memory (ROM), or, as in this example, as executable code within the memory system 112 (e.g., within Random Access Memory or RAM).

In addition to these embodiments, it should also be noted that other embodiments herein include the execution of OVS and FA capabilities application 140-1 in processor 113 as the OVS and FA capabilities process 140-2. Those skilled in the art will understand that the computer system 110 can include other processes and/or software and hardware components, such as an operating system that controls allocation and use of hardware resources associated with the computer system 110. Further, coupling of the device to a specified device is supported wherein communication between said device and any other device is rejected.

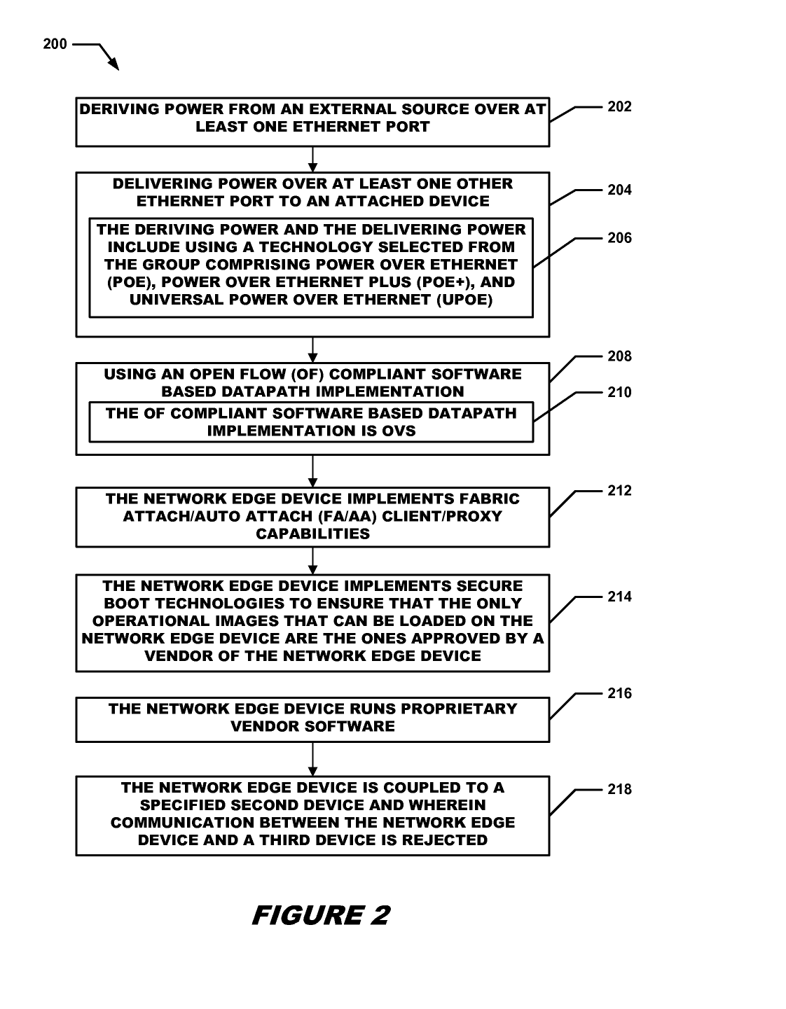

A flow chart of a particular embodiment of the presently disclosed method is depicted in FIG. 2. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 2, a particular embodiment of a network edge device implemented method 200 for providing Power over Ethernet (POE) powered network adapter incorporating Open VSwitch (OVS) and Fabric Attach (FA) capabilities is shown.

Processing begins with processing block 202 which discloses deriving power from an external source over at least one Ethernet port. Processing block 204 states delivering power over at least one other Ethernet port to an attached device. As shown in processing block 206 the deriving power and the delivering power include using a technology selected from the group comprising Power Over Ethernet (PoE), Power Over Ethernet Plus (PoE+), and Universal Power Over Ethernet (UPoE). The device derives power from an external source over one of the Ethernet ports and delivers power over at least one other Ethernet port or ports to attached devices.

Processing block 208 recites using an Open Flow (OF) compliant software based Datapath implementation. As further shown in processing block 210, the OF compliant software based Datapath implementation is OVS. Processing block 212 discloses wherein the network edge device implements Fabric Attach/Auto Attach (FA/AA) client/proxy capabilities.

Processing block 214 recites the network edge device implements secure boot technologies to ensure that the only operational images that can be loaded on the network edge device are the ones approved by a vendor of the network edge device. This secures the device against jail-breaking.

Processing block 216 states the network edge device runs proprietary vendor software. In some embodiments a vendor may develop their own proprietary software to provide the software based Datapath implementation.

Processing block 218 recites the network edge device is coupled to a specified second device and wherein communication between the network edge device and a third device is rejected.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the Internet, as well as a virtual network. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A network edge device comprising:
a memory;
a processor;
a communications interface;
an interconnection mechanism coupling the memory, the processor and the communications interface; and
wherein the memory is encoded with an application providing Power Over Ethernet (POE) powered network adapter incorporating Open VSwitch (OVS) and Fabric Attach (FA) capabilities, that when performed on the processor, provides a process for processing information, the process causing the computer system to perform the operations of:
deriving power from an external source over at least one Ethernet port;
delivering power over at least one other Ethernet port to an attached device; and
using an Open Flow (OF) compliant software based Datapath implementation.

2. The network edge device of claim 1 wherein said deriving power and said delivering power use a technology selected from the group comprising Power Over Ethernet (PoE), Power Over Ethernet Plus (PoE+), and Universal Power Over Ethernet (UPoE).

3. The network edge device of claim 1 wherein a fan is not used for cooling.

4. The network edge device of claim 1 wherein said OF compliant software based Datapath implementation is OVS.

5. The network edge device of claim 1 wherein said network edge device implements Fabric Attach/Auto Attach (FA/AA) client/proxy capabilities.

6. The network edge device of claim 1 wherein said network edge device implements secure boot technologies to ensure that the only operational images that can be loaded on said network edge device are the ones approved by a vendor of said network edge device.

7. The network edge device of claim 1 wherein said network edge device runs proprietary vendor software.

8. The network edge device of claim 1 wherein said network edge device is coupled to a specified second device and wherein communication between said network edge device and a third device is rejected.

9. A network edge device implemented method for providing Power over Ethernet (POE) powered network adapter incorporating Open VSwitch (OVS) and Fabric Attach (FA) capabilities comprising:
deriving power from an external source over at least one Ethernet port;
delivering power over at least one other Ethernet port to an attached device; and
using an Open Flow (OF) compliant software based Datapath implementation.

10. The method of claim 9 wherein said deriving power and said delivering power include using a technology selected from the group comprising Power Over Ethernet (PoE), Power Over Ethernet Plus (PoE+), and Universal Power Over Ethernet (UPoE).

11. The method of claim 9 wherein said OF compliant software based Datapath implementation is OVS.

12. The method of claim 9 wherein said network edge device implements Fabric Attach/Auto Attach (FA/AA) client/proxy capabilities.

13. The method of claim 9 wherein said network edge device implements secure boot technologies to ensure that the only operational images that can be loaded on said network edge device are the ones approved by a vendor of said network edge device.

14. The method of claim 9 wherein said network edge device runs proprietary vendor software.

15. The method of claim 9 wherein said network edge device is coupled to a specified second device and wherein communication between said network edge device and a third device is rejected.

16. A non-transitory computer readable storage medium having computer readable code thereon for providing Power over Ethernet (POE) powered network adapter incorporating Open VSwitch (OVS) and Fabric Attach (FA) capabilities, the medium including instructions in which a network edge device performs operations comprising:
deriving power from an external source over at least one Ethernet port;
delivering power over at least one other Ethernet port to an attached device; and
using an Open Flow (OF) compliant software based Datapath implementation.

17. The non-transitory computer readable storage medium of claim 16 wherein said deriving power and said delivering power include using a technology selected from the group comprising Power Over Ethernet (PoE), Power Over Ethernet Plus (PoE+), and Universal Power Over Ethernet (UPoE).

18. The non-transitory computer readable storage medium of claim 16 wherein said OF compliant software based Datapath implementation is OVS.

19. The non-transitory computer readable storage medium of claim 16 wherein said network edge device implements Fabric Attach/Auto Attach (FA/AA) client/proxy capabilities.

20. The non-transitory computer readable storage medium of claim 16 wherein said network edge device implements secure boot technologies to ensure that the only operational images that can be loaded on said network edge device are the ones approved by a vendor of said network edge device.

21. The non-transitory computer readable storage medium of claim 16 wherein said network edge device runs proprietary vendor software.

22. The non-transitory computer readable storage medium of claim 16 wherein said network edge device is coupled to a specified second device and wherein communication between said network edge device and a third device is rejected.
